(19) United States
(12) Patent Application Publication
(10) Pub. No.: US 2017/0094967 A1
(43) Pub. Date: Apr. 6, 2017

(54) OIL PALM FRUIT APPLICATION METHODS

(71) Applicant: Valent BioSciences Corporation, Libertyville, IL (US)

(72) Inventors: Andrew Rath, Underwood (AU); Peter D. Petracek, Libertyville, IL (US); Johnny Lopez, Artesia, NM (US); Max G. Villalobos Acuna, Alajuela (CR); Gregory D. Venburg, Deerfield, IL (US); Warren E. Shafer, Libertyville, IL (US)

(21) Appl. No.: 15/283,897

(22) Filed: Oct. 3, 2016

Related U.S. Application Data
(60) Provisional application No. 62/237,518, filed on Oct. 5, 2015.

(51) Int. Cl. A01N 37/46; B05B 11/00; A01G 1/00; A01N 31/06; A01G 25/14

(52) U.S. Cl. CPC A01N 37/46; A01N 31/06; A01G 25/14; A01G 1/001; B05B 11/0005

(57) ABSTRACT

The present invention is directed to a device and methods for efficient application of liquid treatment substances to oil palm fruit.

### FIELD OF THE INVENTION

The present invention is directed to a device and methods for efficientapplication of liquid treatment substances to oil palm fruit.

### BACKGROUND OF THE INVENTION

Oil palms (Elaeisguineensis, Elaeisoleifera, or a cross thereof) are palms that are grown to produce oil. Oil palms grow up to 20 meters tall. Their fruit is reddish in color and about the size of a plum. The fruits grow in large bunches which grow around the palm. The time from pollination of the flowers to maturation of the fruit is about five to six months. Oil palms produce bunches year-round and the fruits are harvested as they reach maturity.

The oil palm's fruit consists of a fleshy outer layer that surrounds a palm kernel. Oil is extracted from the pulp of the fleshy outer layer and from the kernel. Oil palm is an important crop for vegetable oil production and is grown on about 15 million hectares worldwide (UNEP Global Environmental Alert Service, December 2011). The demand for palm oil is expected to double by 2020.

To meet the increasing demand for palm oil and improve efficiency, agronomic methods such as tree spacing, increased planting, fertilization, and irrigation as well as genetic improvement have been developed to optimize oil production (Corley, R. H. V. and P. B. Tinker, 2003, The Oil Palm, 4^{th} edition, New York, John Wiley and Sons, 590 pp). There is still a need, however, for methods to increase production of currently planted oil palms. There is also still a need to maximize the oil production of plants produced through genetic improvement. Further, there is a need to increase oil production of the palms managed by spacing, increased planting, fertilization, and irrigation.

AVG ([S]-trans-2-amino-4-(2-aminoethoxy)-3-butenoic acid, aminoethoxyvinylglycine, aviglycine) is a known ethylene antagonist. Applicant found that AVG increases the oil yield of oil palms when AVG is applied before harvest to the fruit (see U.S. patent application Ser. No. 14/641,870).

Similarly, Applicant found that 1-methylcyclopropene (1-MCP) increases the oil yield of oil palm fruit when it is applied before harvest to the fruit (see U.S. patent application Ser. No. 14/708,625). 1-MCP is a gas that inhibits the activity of ethylene (Blankenship and Dole, 2003, Postharvest Biol. Technol. 28:1-25). 1-MCP can be formulated with cyclodextrins to be in liquid form.

Applicant found that it was critical that AVG and 1-MCP are applied directly to the oil palm fruits for them to be effective. Applicant, however, found that it was very difficult given the commercially available equipment to treat the fruit without wasting a lot of the treatment substance as overspray and/or missing a lot of the fruit. Applicant also found that it was time consuming and difficult for the sprayers to reach the fruit.

Accordingly, there is a need for improveddevices and methods for applying liquid treatment substances to oil palm fruits.

### SUMMARY OF THE INVENTION

In one aspect, the present invention is directed to a device for application of a liquid treatment substance to oil palm fruits before they are harvested comprisingat least two air-induction nozzles fitted with flat-fan spray heads wherein a first spray head is positioned to spray vertically and a second spray head is positioned to spray horizontally, the nozzles are attached to a spray wand, a first nozzle is disposed at a angle of from about 70 to about 110 degree angle from the spray wand, a second nozzle is disposed at a angle of from about 115 to about 155 degree angle from the spray wand, and a hose to connect the spray wand to a tank that contains the liquid treatment substance.

In a further aspect, the present invention is directed to methods for improving the application of a liquid treatment substance to oil palm fruits comprising the step of applying a liquid treatment substance to oil palm fruit before the fruit is harvested with an air-induction nozzle fitted with at least two flat-fan spray heads on a spray wand, wherein a first nozzle is from about 70 to about 110 degrees from the spray wand, a second nozzle is from about 115 to about 155 degrees from the spray wand, a first spray head that is positioned to spray horizontally, and a second spray head that is positioned to spray vertically.

In another aspect, the present invention is directed to methods for improving the application of AVG to oil palm fruits comprising the step of applying AVG, or a salt thereof, to oil palm fruit before the fruit is harvested with an air-induction nozzle fitted with at least two 110 degree flat-fan spray heads on a telescoping spray wand,wherein a first nozzle is from about 70 to about 110 degrees from the telescoping spray wand, a second nozzle is from about 115 to about 155 degrees from the telescoping spray wand, a first spray head that is positioned to spray horizontally, and a second spray head that is positioned to spray vertically.

In yet another aspect, the present invention is directed to methods for improving the application of 1-MCP to oil palm fruits comprising the step of applying 1-MCP, or a salt thereof, to oil palm fruit before the fruit is harvested with an air-induction nozzle fitted with at least two 110 degree flat-fan spray heads on a telescoping spray wand,wherein a first nozzle is from about 70 to about 110 degrees from the telescoping spray wand, a second nozzle is from about 115 to about 155 degrees from the telescoping spray wand, a first spray head that is positioned to spray horizontally, and a second spray head that is positioned to spray vertically.

### BRIEF DESCRIPTION OF THE FIGURES

FIG. 1 shows two air-induction nozzles, each with a flat-fan spray head.

FIG. 2 shows an air-induction nozzle with flat-fan spray heads mounted on a telescoping spray wand.

FIG. 3 shows a spray tank mounted on a 6 wheel all-terrain vehicle.

### DETAILED DESCRIPTION OF THE INVENTION

Applicant unexpectedly discovered new methods and a device for applying liquid treatment substances to oil palm fruits. Specifically, Applicant found that having two air-induction nozzles at specific angles on a spray wand with flat-fan spray heads perpendicular to each other was very effective.

This method significantly reduces overspray because it allows for precise spraying. Further, using air induction allows for the liquid treatment substance to be mixed with air in the nozzle forming droplets that provide excellent coverage of the fruit. Applicant also found that this method allows for efficient spraying as a two-man team can cover 10 to 12 hectares per day. The spray wand was also critical as it allowed for the sprayers to reach fruit anywhere on the plants.

In one embodiment,the present invention is directed to a device for application of a liquid treatment substance to oil palm fruits before they are harvested comprisingat least two air-induction nozzles fitted with flat-fan spray heads wherein a first spray head is positioned to spray vertically and a second spray head is positioned to spray horizontally, the nozzles are attached to a spray wand, a first nozzle is disposed at a angle of from about 70 to about 110 degree angle from the spray wand, a second nozzle is disposed at a angle of from about 115 to about 155 degree angle from the spray wand, and a hose to connect the spray wand to a tank that contains the liquid treatment substance.

In yet another embodiment, the first nozzle of the device is disposed at an angle from about 80 to about 100 degrees from the spray wand. In a preferred embodiment, the first nozzle is disposed at an angle of about 90 degrees from the spray wand.

In an embodiment, the second nozzle of the device is disposed at an angle from about 125 to about 145 degrees from the spray wand. In a preferred embodiment, the second nozzle is disposed at an angle of about 135 degrees from the spray wand.

In an embodiment, the spray wand of the device is telescoping.

The spray wand can be attached via a hose to a spray tank containing the liquid treatment substance. The tank can be worn as a backpack, pulled by a tractor, or mounted on a 4 or 6 wheel all-terrain vehicle. In a preferred embodiment, the tank of the device is mounted on a 6 wheel all terrain vehicle. This vehicle, for example, can have a 200 liter tank.

The tank of the device can have multiple hoses so that many people can apply the treatment substance at the same time. In another embodiment, the hose or hoses are remote-controlled. In an embodiment, the hose or hoses are retractable.

In another embodiment, the present invention is directed to methods for improving the application of a liquid treatment substance to oil palm fruits comprising the step of applying a liquid treatment substance to oil palm fruit before the fruit is harvested with an air-induction nozzle fitted with at least two flat-fan spray heads on a spray wand,wherein a first nozzle is from about 70 to about 110 degrees from the spray wand, a second nozzle is from about 115 to about 155 degrees from the spray wand, a first spray headis positioned to spray vertically, and a second spray head is positioned to spray horizontally.

In a preferred embodiment, the liquid treatment substance comprises AVG, 1-MCP, or a salt thereof. In a more preferred embodiment, the liquid treatment substance comprises AVG, or a salt thereof. In a most preferred embodiment, the liquid treatment substance comprises AVG-HCl.

In an alternative embodiment, the liquid treatment substance comprises 1-MCP, or a salt thereof.

In another embodiment, a first flat-fan spray head delivers the liquid treatment substance to the oil palm fruit at an angle of from about 80 to about 140 degrees. In a preferred embodiment, the first flat-fan spray head delivers the liquid treatment substance to the oil palm fruit at an angle of from about 100 to about 120 degrees. In a more preferred embodiment, the first flat-fan spray head delivers the liquid treatment substance to the oil palm fruit at an angle of about 110 degrees.

In a further embodiment, a second flat-fan spray head delivers the liquid treatment substance to the oil palm fruit at an angle of from about 80 to about 140 degrees. In a preferred embodiment, the second flat-fan spray head delivers the liquid treatment substance to the oil palm fruit at an angle of from about 100 to about 120 degrees. In a more preferred embodiment, the second flat-fan spray head delivers the liquid treatment substance to the oil palm fruit at an angle of about 110 degrees.

In yet another embodiment, the first nozzle is from about 80 to about 100 degrees from the spray wand. In a preferred embodiment, the first nozzle is about 90 degrees from the spray wand.

In an embodiment, the second nozzle is from about 125 to about 145 degrees from the spray wand. In a preferred embodiment, the second nozzle is about 135 degrees from the spray wand.

In an embodiment, the spray wand is telescoping.

The spray wand can be attached via a hose to a spray tank containing the liquid treatment substance. The tank can be worn as a backpack, pulled by a tractor, or mounted on a 4 or 6 wheel all-terrain vehicle. In a preferred embodiment, the tank is mounted on a 6 wheel all terrain vehicle. This vehicle, for example, can have a 200 liter tank.

The tank can have multiple hoses so that many people can apply the treatment substance at the same time. In another embodiment, the hose or hoses are remote-controlled. In an embodiment, the hose or hoses are retractable.

The liquid treatment substance can be formulated prior to putting it into the spray tank. Also, adjuvants such as surfactants, humectants, stickers, spreaders, urea, oils, and salts may be incorporated in the spray tank to improve performance of the liquid treatment substance.

In another embodiment, the first nozzle is calibrated to deliver to the oil palm fruit from about 200 to about 600 milliliters of water with the liquid treatment substance in solution per minute. In a preferred embodiment, the first nozzle is calibrated to deliver to the oil palm fruit from about 300 to about 500 milliliters of water with the liquid treatment substance in solution per minute. In a more preferred embodiment, the first nozzle is calibrated to deliver to the oil palm fruit about 400 milliliters milliliters of water with the liquid treatment substance in solution per minute.

In another embodiment, the second nozzle is calibrated to deliver to the oil palm fruit from about 200 to about 600 milliliters milliliters of water with the liquid treatment substance in solution per minute. In a preferred embodiment, the second nozzle is calibrated to deliver to the oil palm fruit from about 300 to about 500 milliliters milliliters of water with the liquid treatment substance in solution per minute. In a more preferred embodiment, the second nozzle is calibrated to deliver to the oil palm fruit about 400 milliliters milliliters of water with the liquid treatment substance in solution per minute.

In a further embodiment, one or more additional nozzles are added to the spray wand. If more than two nozzles are on the spray wand, the rate of application may be adjusted for each nozzles to achieve the desired rate of application of treatment substance.

In a preferred embodiment, the methods of the present invention produce an increase in oil yield from the treated oil palm fruits.

The timing of application of the treatment substance to the fruit is after formation of the fruit. This timing does not include when the oil palm is a seedling. Preferably, the timing range is from just prior to initial fruit drop through early fruit drop from the most mature bunch or bunches on the oil palm. This timing corresponds to about 3 to 4 weeks before harvest to the day of harvest. Most preferably, the timing corresponds to 1 to 2 weeks before harvest to the day of harvest.

In yet another embodiment, the present invention is directed to methods for improving the application of AVG to oil palm fruits comprising the step of applying AVG, or a salt thereof, to oil palm fruit before the fruit is harvested with an air-induction nozzle fitted with at least two 110 degree flat-fan spray heads on a telescoping spray wand,wherein a first nozzle is about 90 degrees from the telescoping spray wand, a second nozzle is about 135 degrees from the telescoping spray wand,a first spray head is positioned to spray vertically, anda second spray head is positioned to spray horizontally. In a preferred embodiment, the AVG salt is AVG-HCl.

Preferably, the concentration of AVG, or a salt thereof, that is applied to the fruit is from about 1 to about 10,000 ppm. The more preferred concentration is from about 20 to about 2,000 ppm. The most preferred concentration is from about 100 to about 500 ppm.

Preferably, the AVG, or a salt thereof, dose is from about 0.02 mg to about 20 g per palm per application. The more preferred AVG, or a salt thereof, dose is from about 0.4 mg to about 4000 mg per palm per application. The most preferred AVG, or a salt thereof, dose is from about 10 mg to about 300 mg per palm per application.

The preferred interval of application of AVG, or a salt thereof, is from about every 7 to about every 21 days. The most preferred interval of application is from about every 10 to about every 14 days.

In an alternative embodiment, the present invention is directed to methods for improving the application of 1-MCP to oil palm fruits comprising the step of applying 1-MCP, or a salt thereof, to oil palm fruit before the fruit is harvested with an air-induction nozzle fitted with at least two 110 degree flat-fan spray heads on a telescoping spray wand,wherein a first nozzle is about 90 degrees from the telescoping spray wand, a second nozzle is about 135 degrees from the telescoping spray wand,a first spray head is positioned to spray vertically, anda second spray head is positioned to spray horizontally.

1-MCP may be applied in one treatment or via multiple treatments. In a preferred embodiment, 1-MCP is applied 1 to 8 times to maturing fruit on the palm tree. If 1-MCP is applied multiple times, the preferred frequency is 2 to 6 times with an interval of application about every 7 to 35 days. The most preferred interval of application is from about every 10 to about every 21 days.

In yet another embodiment, the liquid treatment substance can include AVG, or a salt thereof, and 1-MCP, or a salt thereof.

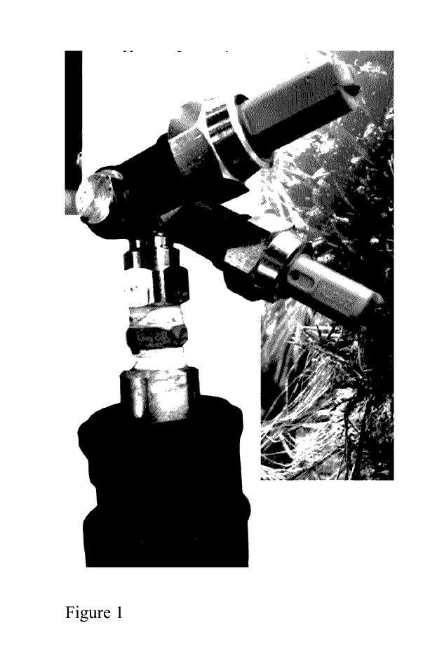

FIG. 1 shows two air-induction nozzles, each with a flat-fan spray head. The air induction nozzles have holes on the sides of the nozzles which allow air to mix with the solution containing the liquid treatment substance. One such hole is visible on the lower spray head. Each spray head has a slit-like opening which projects the solution in the flat-fan shape.

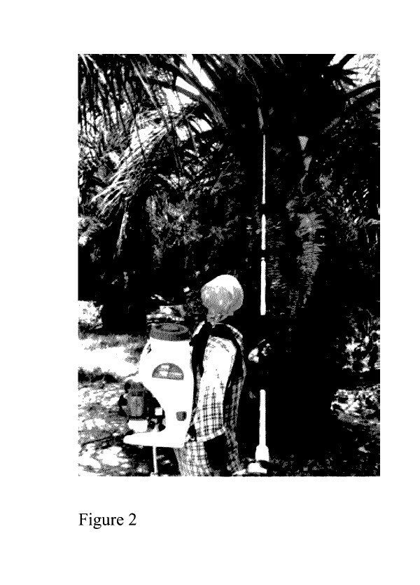

FIG. 2 shows an air-induction nozzle with flat-fan spray heads mounted on a telescoping spray wand. This configuration allows the sprayer to reach the fruits that are several kilometers off of the ground. This configuration does not require the use of a heavy and potentially dangerous ladder.

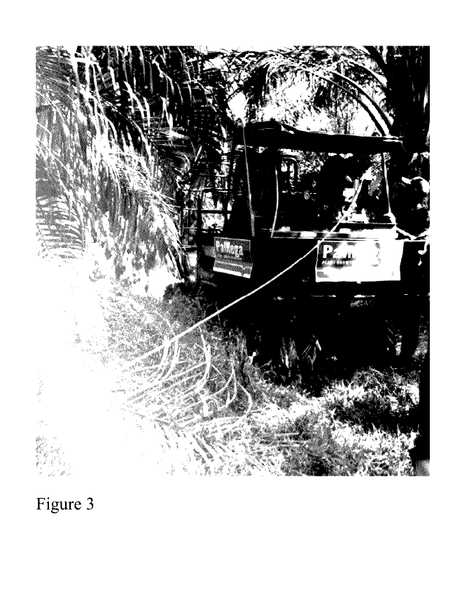

FIG. 3 shows a spray tank mounted on a 6 wheel all-terrain vehicle. In this embodiment, the hoses are visible. The hoses transport the solution containing the liquid treatment substance to the spray wands and then to the nozzles and spray heads for application to the fruits.

As used herein, “yield” refers to the amount of oil that is produced from the oil palm.

As used herein, an “air induction” nozzle refers to nozzle which has an internal constriction which creates a negative pressure inside the nozzle body and at least one hole in the nozzle body from which air is drawn into the nozzle.

As used herein, “flat-fan” refers to a spray pattern that is relatively flat and resembles a “V” shaped as it emerges from the spray head.

As used herein, a “telescoping” wand refers to one that can be expanded to extend the length of the wand, or it can be collapsed to decrease the length of the wand.

As used herein, “before harvest,” refers to a time before the fruit is removed or falls from the oil palm plant.

As used herein, “liquid treatment substance” refers to a substance in liquid form that can be applied to treat oil palm fruits.

As used herein, “positioned to spray vertically” means that the spray head is adjusted so that when the spray wand is held upright, the fan shape created by the flat-fan spray head is perpendicular to the plane of the horizon.

As used herein, “positioned to spray horizontally” means that the spray head is adjusted so that when the spray wand is held upright, the fan shape created by the flat-fan spray head is parallel to the plane of the horizon.

Throughout the application, the singular forms “a,” “an,” and “the” include plural reference unless the context clearly dictates otherwise.

As used herein, all numerical values relating to amounts, weight percentages and the like are defined as “about” or “approximately” each particular value, plus or minus 10%. For example, the phrase “at least 5.0% by weight” is to be understood as “at least 4.5% to 5.5% by weight.” Therefore, amounts within 10% of the claimed values are encompassed by the scope of the claims.

These representative embodiments are in no way limiting and are described solely to illustrate some aspects of the invention.

The invention is demonstrated by following representative examples. The following examples are offered by way of illustration only and not by way of limitation.

### EXAMPLE

### Example 1

A study was executed in a plantation in Malaysia to developmore effectivemethods for application of liquid treatment substances to oil palm fruits. Different sprayers and nozzleswere tested to provide resource efficient applications of liquid treatment substances to oil palm fruits.

Nozzles with different angles and configurations were tested. It was determined that dual, twin-spray air induction nozzles provided the best coverage of the oil palm fruits with the least amount of wasteful overspray. The twin nozzles should at about 135 and 90 degrees from the telescoping wand.

Spray heads with different shapes were also tested. It was determined that 110 degree flat-fan spray heads were the most effective on the twin-spray nozzles. Further, the spray heads should be in an orientation perpendicular to each other so one sprays horizontally and one vertically.

In addition, it was determined that the nozzles should be calibrated to deliver about 400 milliliters per minute each. This allowed for quick treatments of only about 15 seconds per palm. The palms received about 200 ml of total liquid treatment substance per palm.

Further, Applicant found that using hand-held telescoping spray wands was critical to being able to reach the fruits.

We claim:

1. A device for application of a liquid treatment substance to oil palm fruits before they are harvested comprising:
at least two air-induction nozzles fitted with flat-fan spray heads wherein a first spray head ispositioned to spray vertically and a second spray head is positioned to spray horizontally;
the nozzles are attached to a spray wand;
a first nozzle is disposed at a angle offrom about 70 to about 110 degree angle from the spray wand;
a second nozzle is disposed at a angle of from about 115 to about 155 degreeangle from the spray wand;
anda hose to connect the spray wand to a tank that contains the liquid treatment sub stance.

2. A method for improving the application of a liquid treatment substance to oil palm fruits comprising the step of:
applying a liquid treatment substance to oil palm fruit before the fruit is harvested with annozzle fitted with at least two flat-fan spray heads on a spray wand,
wherein a first nozzle is from about 70 to about 110 degrees from the spray wand,
a second nozzle is from about 115 to about 155 degrees from the spray wand,
a first spray headis positioned to spray vertically,
and a second spray head is positioned to spray horizontally.

3. The method of claim 2 wherein the liquid treatment substance comprises AVG, 1-MCP, or a salt thereof.

4. The method of claim 3 wherein the liquid treatment substance comprisesAVG, or a salt thereof.

5. The method of claim 4 wherein the salt is AVG-HCl.

6. The method of claim 3 wherein the liquid treatment substance comprises 1-MCP, or a salt thereof.

7. The method of claim 2 wherein a first flat-fan spray head delivers the liquid treatment substance to the oil palm fruit at an angle of from about 80 to about 140 degrees.

8. The method of claim 7 wherein the first flat-fan spray head delivers the liquid treatment substance to the oil palm fruit at an angle of from about 100 to about 120 degrees.

9. The method of claim 2 wherein a second flat-fan spray head delivers the liquid treatment substance to the oil palm fruit at an angle of from about 80 to about 140 degrees.

10. The method of claim 9 wherein the second flat-fan spray head delivers the liquid treatment substance to the oil palm fruit at an angle of from about 100 to about 120 degrees.

11. The method of claim 2 wherein the first nozzle is from about 80 to about 100 degrees from the spray wand.

12. The method of claim 2 wherein the first nozzle is about 90 degrees from the spray wand.

13. The method of claim 1 wherein the second nozzle is from about 125 to about 145 degrees from the spray wand.

14. The method of claim 2 wherein the second nozzle is about 135 degrees from the spray wand.

15. The method of claim 2 wherein the first nozzle is calibrated to deliver to the oil palm fruit from about 200 to about 600 milliliters per minute.

16. The method of claim 2 wherein the first nozzle is calibrated to deliver to the oil palm fruit from about 300 to about 500 milliliters per minute.

17. The method of claim 2 wherein the firstnozzle is calibrated to deliver to the oil palm fruitabout 400 milliliters per minute.

18. The method of claim 2 wherein the oil yield of the oil palm fruit is increased.

19. The method of claim 2 wherein the liquid treatment substanceis applied from about three weeks before the fruit is harvested to about the day before the fruit is harvested.

20. A method for improving the application of AVG or 1-MCP to oil palm fruits comprising the step of:
applying AVG, 1-MCP, or a salt thereof, to oil palm fruit before the fruit is harvested with an air-induction nozzle fitted with at least two 110 degree flat-fan spray heads on a telescoping spray wand,
wherein a first nozzle is about 90 degrees from the telescoping spray wand,
a second nozzle is about 135 degrees from the telescoping spray wand,
a first spray head is positioned to spray vertically, and
a second spray head is positioned to spray horizontally.
